(19) United States
(12) Patent Application Publication
(10) Pub. No.: US 2012/0221947 A1
(43) Pub. Date: Aug. 30, 2012

(54) INFORMATION PROCESSING APPARATUS AND METHOD

(75) Inventors: Reiji YUKUMOTO, Kanagawa (JP); Tetsuo Asakawa, Tokyo (JP); Osamu Torii, Kanagawa (JP); Masafumi Nagao, Kanagawa (JP); Miki Oouchi, Kanagawa (JP); Daisuke Noguchi, Kanagawa (JP)

(73) Assignee: RICOH COMPANY, LTD.

(21) Appl. No.: 13/400,747

(22) Filed: Feb. 21, 2012

(30) Foreign Application Priority Data
Feb. 24, 2011 (JP) 2011-038083

(51) Int. Cl. G06F 17/00

(52) U.S. Cl. 715/273

(57) ABSTRACT

An information processing apparatus is connected to a viewing apparatus through which a document is viewed. A view management part creates view information that indicates a viewed portion of the document where the document has been viewed. A document management part creates change information that indicates a changed portion of the document where the document has been changed. A creation part creates individual apparatus basis change information that indicates a coincident portion where the viewed portion indicated in the view information and the changed portion indicated in the change information are coincident with each other. A transmission part transmits the individual apparatus basis change information to the viewing apparatus through which the document was viewed.

### BACKGROUND OF THE INVENTION

1. Field of the Invention

The present invention relates to an information processing apparatus and method.

2. Description of the Related Art

Conventionally, there is known a system consisting of a document server for distributing documents and a viewing apparatus through which the documents can be viewed by a viewer. In this system, when a document stored in the document server is updated, update information is sent to a viewer of the document. According to this structure, a viewer of a document can always view an updated document (for example, refer to Japanese Laid-Open Patent Application No. 2005-234655).

According to the technique disclosed in Japanese Laid-Open Patent Application No. 2005-234655, the same update information is sent to all users. That is, unnecessary update information is sent depending on the users. As a result, there is a problem in that a user who uses a viewing apparatus must recognize or distinguish a piece of information which the user needs from among pieces of update information.

### SUMMARY OF THE INVENTION

It is a general object of the present invention to provide an image processing apparatus and method in which the above-mentioned problem is eliminated.

A more specific object of the present invention is to provide an image processing apparatus and method which can save trouble that a user must find information, which the user needs, from among pieces of update information received by a viewing apparatus.

In order to achieve the object, there is provided according to one aspect of the present invention an information processing apparatus to be connected to a viewing apparatus through which a document is viewed, the information processing apparatus including: a view management part configured to create view information that indicates a viewed portion of the document where the document has been viewed; a document management part configured to create change information that indicates a changed portion of the document where the document has been changed; a creation part configured to create individual apparatus basis change information that indicates a coincident portion where the viewed portion indicated in the view information and the changed portion indicated in the change information are coincident with each other; and a transmission part configured to transmit the individual apparatus basis change information to the viewing apparatus through which the document was viewed.

There is provided according to another aspect of the present invention an information processing method including: a step of creating view information that indicates a viewed portion of a document where the document has been viewed through a viewing apparatus; a step of creating change information that indicates a changed portion of the document where the document has been changed; a step of creating individual apparatus basis change information that indicates a coincident portion where the viewed portion indicated in the view information and the changed portion indicated in the change information are coincident with each other; and a step of transmitting the individual apparatus basis change information to the viewing apparatus through which the document was viewed.

Further, there is provided a non-transitory computer readable recording medium storing a program to cause a computer to perform the above-mentioned information processing method.

According to the present invention, the information processing apparatus and method can save trouble that a user who uses a viewing apparatus must recognize or distinguish a piece of information, which the user needs, from among pieces of update information.

Other objects, features and advantages of the present invention will become more apparent from the following detailed description when read in conjunction with the accompanying drawings.

### BRIEF DESCRIPTION OF THE DRAWINGS

FIG. 1 is an illustration of a functional structure of a document management system according to a first embodiment of the present invention;

FIG. 2 is an illustration of a functional structure of an information processing apparatus according to the first embodiment;

FIG. 3 is a flowchart of a process performed by the information processing apparatus according to the first embodiment;

FIG. 4 is an illustration of an example of change information according to the first embodiment;

FIG. 5 is an illustration of an example of view information according to the first embodiment;

FIG. 6 is an illustration of an example of individual apparatus basis change information according to the first embodiment;

FIG. 7 is a flowchart of a method of producing the individual apparatus basis change information according to the first embodiment;

FIG. 8 is an illustration of an example of change information according to a second embodiment;

FIG. 9 is an illustration of an example of individual apparatus basis change information according to the second embodiment;

FIG. 10 is a flowchart of a method of producing individual apparatus basis change information according to the second embodiment;

FIG. 11 is an illustration of an example of view information according to a third embodiment;

FIG. 12 is a flowchart of a process performed by an information processing apparatus according to the third embodiment;

FIG. 13 is an illustration of an example of a correspondence table according to a fourth embodiment;

FIG. 14 is a flowchart of a process performed by an information processing apparatus according to the fourth embodiment;

FIG. 15A is an illustration of a document before change;

FIG. 15B is an illustration of the document after change;

FIG. 15C is an illustration of the document after integration; and

FIG. 16 is a flowchart of a process performed by an information processing apparatus according to the fifth embodiment.

### DETAILED DESCRIPTION OF THE PREFERRED EMBODIMENTS

A description will be given below, with reference to the drawings, of embodiments of the present invention.

### First Embodiment

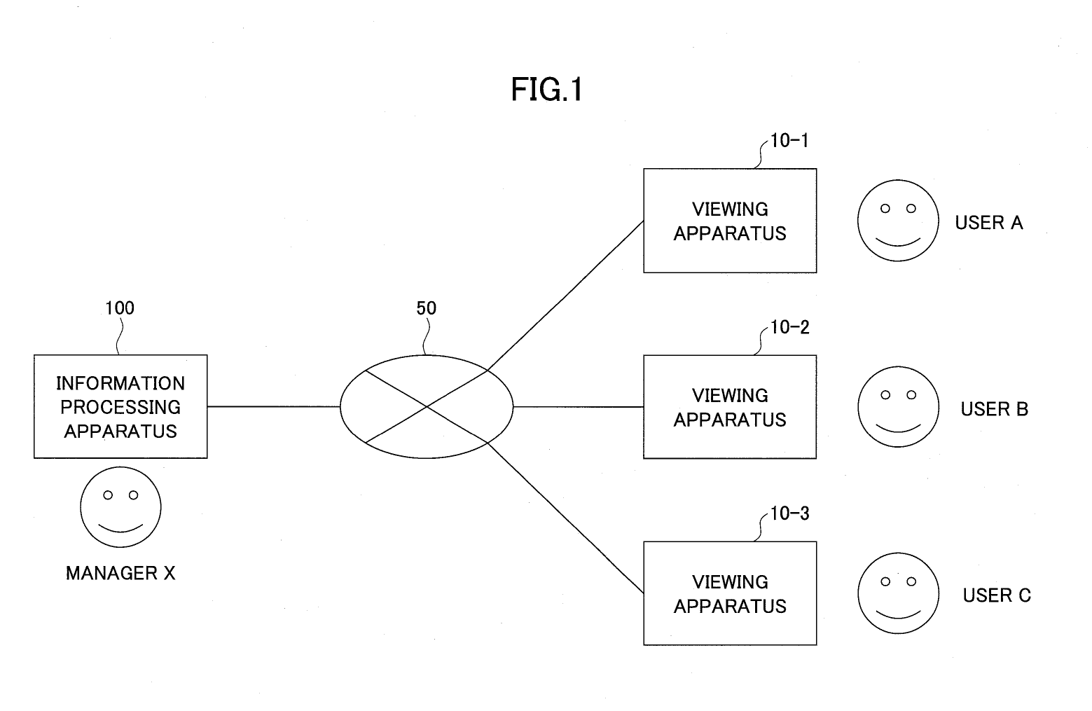

A description will be given, with reference to FIG. 1, of an information processing apparatus according to a first embodiment. The information processing apparatus according to the first embodiment serves as a document management apparatus, which manages documents. Here, a document is an object to be viewed by a user, and includes symbols, characters and figures. Hereinafter, the term “document” is used as both a paper document and an electronic document (document data). FIG. 1 illustrates a functional structure of a document management system according to the present embodiment. In the example of FIG. 1, an information processing apparatus 100 and a plurality of viewing apparatuses 10-1 to 10-3 (three apparatuses illustrated in FIG. 1) are mutually connected by a network 50. Hereinafter, the plurality of viewing apparatuses 10-1 to 10-3 may be collectively referred to as a viewing apparatus 10.

The viewing apparatus 10 allows a user (viewer) to view documents and various pieces of information that are sent from the information processing apparatus 100. The viewing apparatus 10 can be, for example, a desktop-type personal computer (desktop PC), notebook-type personal computer (note PC), a smartphone, a projector, etc. It is assumed that users A to C have the viewing apparatuses 10-1 to 10-3, respectively, so that the users A to C can view documents and various pieces of information through the respective viewing apparatuses 10-1 to 10-3.

The information processing apparatus 100 stores document data, etc., and the document data are sent to the viewing apparatuses 10-1 to 10-3. A manager X is allowed to change the document data through the information processing apparatus 100. Here, such a change of the document data means, for example, updating the document data.

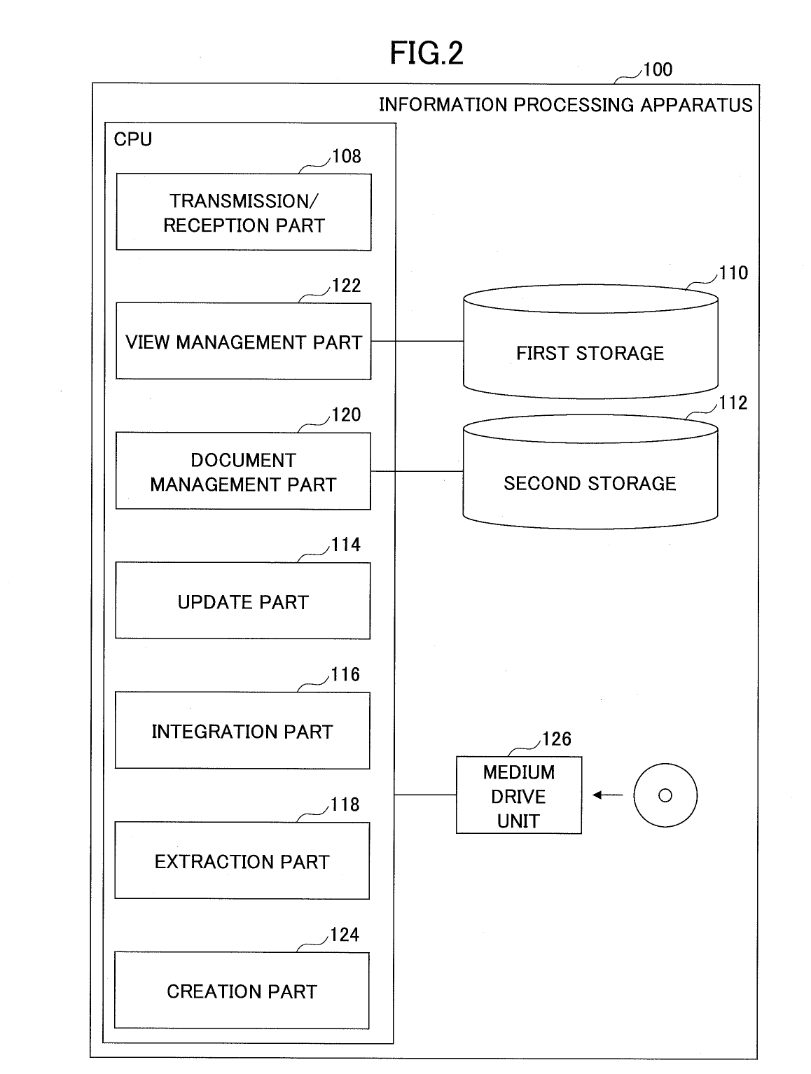

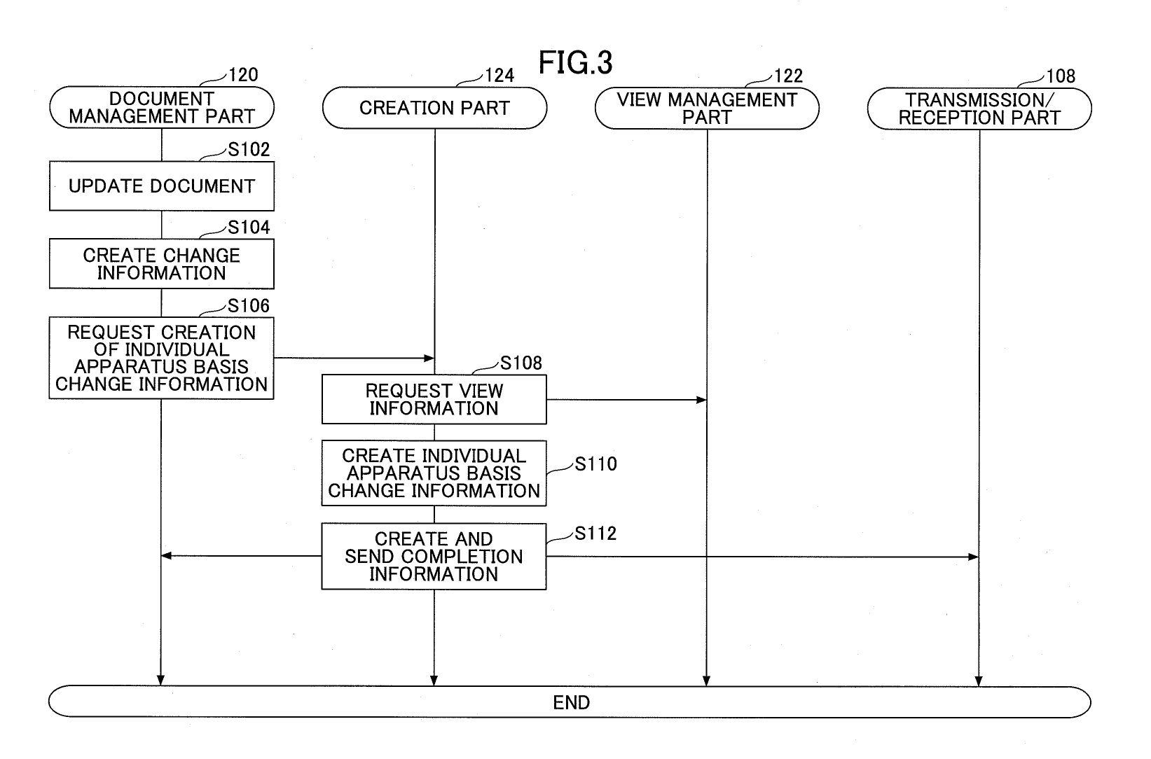

FIG. 2 illustrates a functional structure of the information processing apparatus 100. FIG. 3 is a flowchart of a process performed by the information processing apparatus 100. First, the manager X updates a document using the information processing apparatus 100 (step S102). The document is stored in a second storage 112 of the information processing apparatus 100. When the manager X instructs the information processing apparatus 100 to perform a process of updating a document, the document stored in the second storage 112 is updated. Then, a document management part 120 of the information processing apparatus 100 creates change information (step S104).

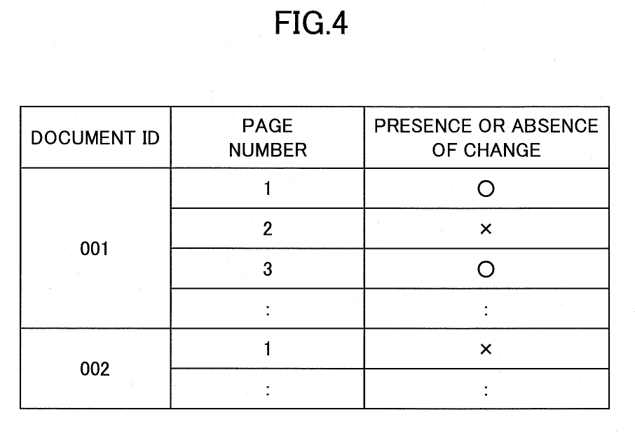

An example of the change information is illustrated in FIG. 4. The change information is information indicating a position or portion (hereinafter, referred to as “changed portion”) where the document has been changed. Here, the changed portion is expressed by a unit section, which corresponds to a “page” in the present embodiment. In FIG. 4, a page number and presence or absence of change are determined on an individual document ID basis. The document ID is information for identifying a document. With respect to signs “∘” and “X” in the column of “presence or absence of change”, the sign “∘” is provided when a change has been made and the sign “X” is provided when a change has not been made. For example, with respect to the page number “1” of the document ID “001”, it is indicated that the document has been changed. That is, FIG. 4 indicates that the position where the document of the document ID=001 is changed is present in the first page and the third page.

When the manager X makes a change in a document, the manager X inputs change contents information which indicates the document ID of the document of which a change is desired and contents of the change. The change contents information is information indicating a change to be made in the document such as, for example, a change from “a is b” into “b is a” or deletion of recitation “b is c”. It should be noted that the change contents information is not illustrated in FIG. 4.

When the change contents information, which indicates the document ID of the document of which change is desired and contents of the change, is input by the manager X, the document management part 120 creates change information. When the change information is created, the document management part 120 makes a request of producing individual apparatus basis change information to a creation part 124. The individual apparatus basis change information will be explained in detail later. Specifically, the request of creating is performed by the document management part 120 by sending a creation request signal to the creation part 124 (step S106).

Upon reception of the creation request signal, the creation part 124 requests a view management part 122 to send view information, which is necessary for creating the individual apparatus basis change information, by sending a view information request signal (step S108). Here, the view management part 122 manages information as to whether or not a user has viewed a unit section (here, a page) with respect to the unit section which the user has viewed. When the user views the document, the document ID of the document viewed by the user and the number of page viewed by the user are sent from the viewing apparatus 10 to the information processing apparatus 100. Then, the view information is stored in a first storage 110 based on the document ID and the page number sent from the viewing apparatus 10.

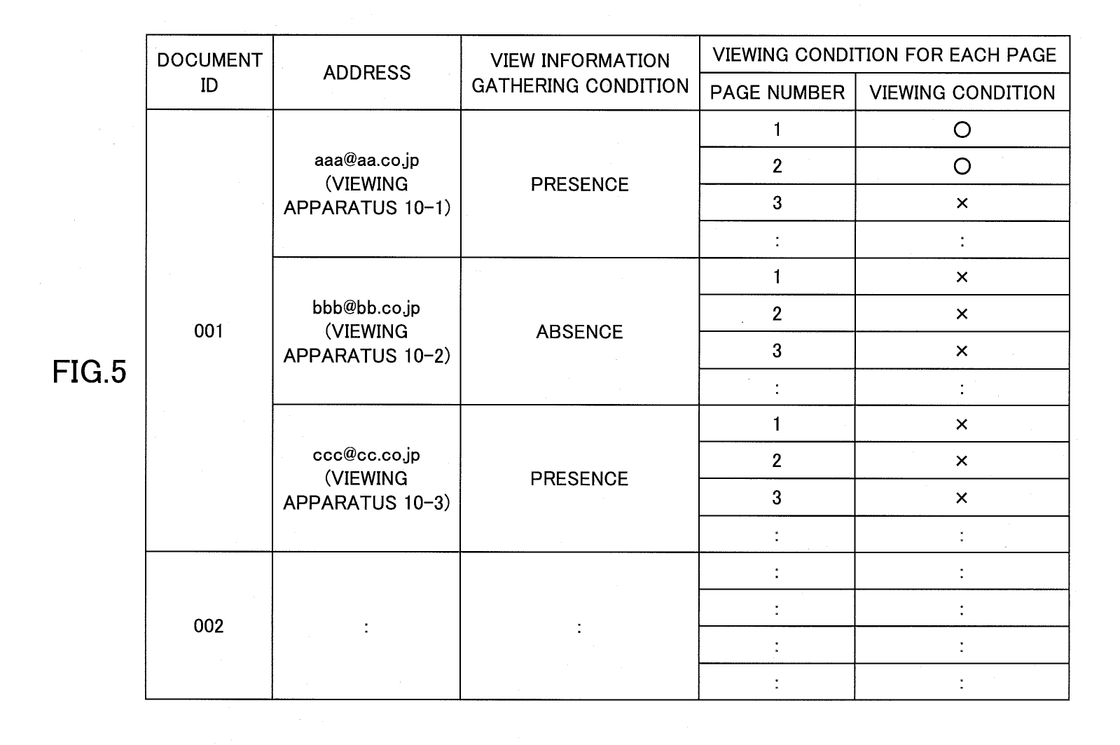

An example of the view information is illustrated in FIG. 5. In the example of FIG. 5, an address of the viewing apparatus, a view information gathering condition, and a viewing condition for each page are determined for each document ID. The address of the viewing apparatus is given to each viewing apparatus 10. Hereinafter, the address of the viewing apparatus 10-1, which the user A uses for viewing, is set to “aaa@aa.co.jp”, the address of the viewing apparatus 10-2, which the user B uses for viewing, is set to “bbb@bb.co.jp”, and the address of the viewing apparatus 10-3, which the user C uses for viewing is set to “ccc@cc.co.jp.”

The view information gathering condition is information as to whether the view information has been sent from each viewing apparatus 10. FIG. 5 indicates that the view information has been sent from the viewing apparatus 10-1 and the viewing apparatus 10-3, but has not been sent from the viewing apparatus 10-2.

The viewing condition for each page is information indicating whether the page has been viewed for each page. That is, in the example of FIG. 5, it is indicated that the user A has viewed the first page of the document ID “001” by the viewing apparatus 10-1. Thus, the first storage 110 stores view information indicating the viewed position of the document viewed by the user. It should be noted that the view information may contain a position which has not been viewed (for example, the third page of the document of the document ID “001”). Then, when each user views the document by the viewing apparatus 10, the view information is updated as needed.

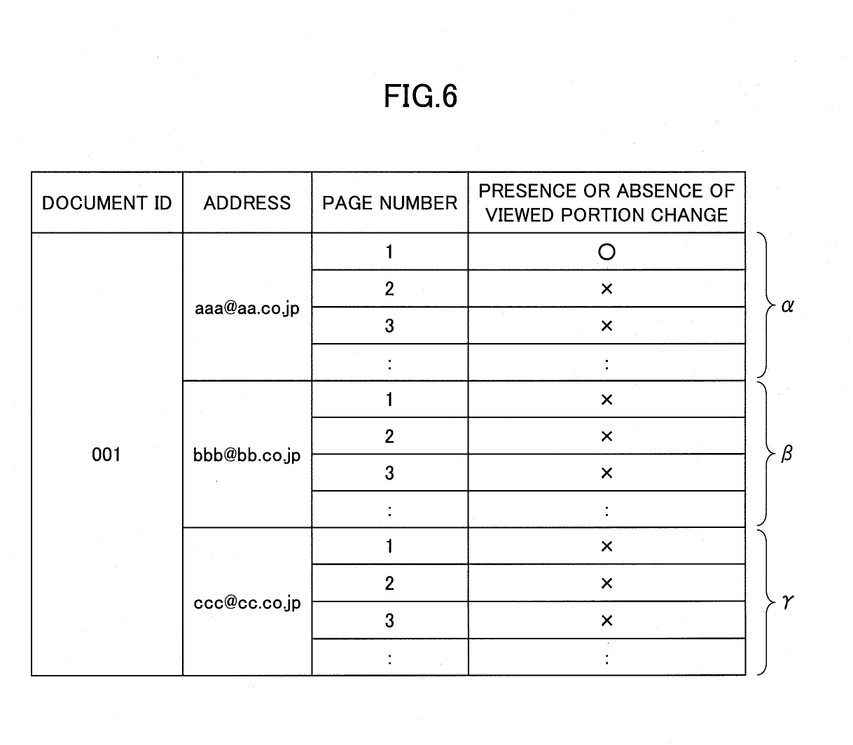

Returning to FIG. 3, upon reception of the view information request signal, the view management part 122 acquires the view information stored in the first storage 110 and sends the view information to the creation part 124. The creation part 124 creates individual apparatus basis change information from the change information sent from the document management part 120 and the view information sent from the view management part 122 (step S110). An example of the individual apparatus basis change information is illustrated in FIG. 6. The individual apparatus basis change information indicates a coincident portion where a portion viewed by the viewing apparatus 10 (a viewed portion indicated in the view information) is coincident with the changed portion (a changed portion indicated in the change information). In the example of FIG. 6, the information is indicated in the column of “presence or absence of viewed portion change”, which indicates whether it is a portion which has been viewed and has been changed. If the “presence or absence of viewed portion change” indicates “∘”, it indicates that it is a portion which has been viewed and changed. If the “presence or absence of viewed portion change” indicates “X”, it indicates that it is a portion which has been viewed but has not been changed, or it is a portion which has not been viewed but has been changed, or it is a portion which has not been viewed and changed. The individual apparatus basis change information is created for each viewing apparatus 10.

In FIG. 6, a page number and an indication of presence or absence of viewed portion change are indicated for each viewing apparatus 10. In FIG. 6, with respect to the document of the document ID “001”, it is indicated by providing “∘” that the page number “1” of the viewing apparatus 10-1 has been changed. Although FIG. 6 illustrates only the document of the document ID=“001” for the purpose of simplification of drawings, a page number and an indication of presence or absence of viewed portion change are created for other documents having different document IDs.

Then, the individual apparatus basis change information is created for each viewing apparatus 10. In the example illustrated in FIG. 6, individual apparatus basis change information α is created for the viewing apparatus 10-1, individual apparatus basis change information β is created for the viewing apparatus 10-2, and individual apparatus basis change information γ is created for the viewing apparatus 10-3.

After creating the individual apparatus basis change information, the creation part 124 sends completion information, which indicates that the creation was completed, to the document management part 120, and also sends the created individual apparatus basis change information to the transmission/reception part 108 (step S112). Then, the transmission/reception part 108 transmits the individual apparatus basis change information corresponding to each viewing apparatus 10. The created individual apparatus basis change information may be sent to the document management part 120 together with the completion information so that the thus-sent individual apparatus basis change information may be sent to the transmission/reception part 108.

<Method of Creating Individual Apparatus Basis Change Information>

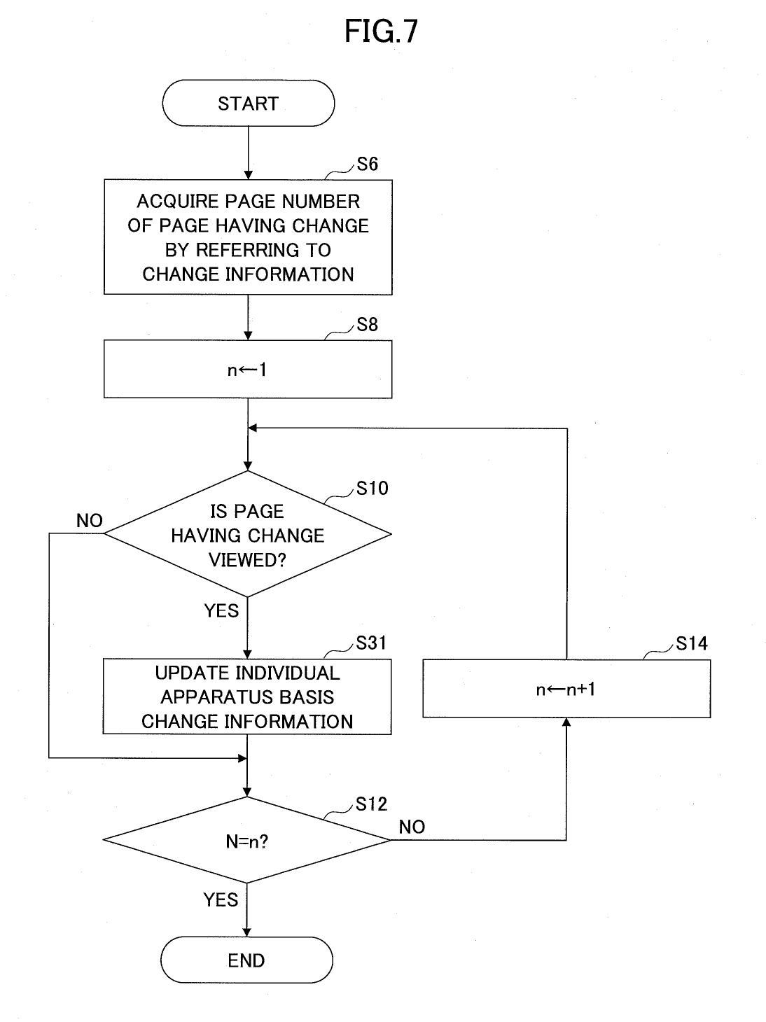

A description is given below of a method of creating the above-mentioned individual apparatus basis change information. FIG. 7 illustrates a flowchart of a method of creating the individual apparatus basis change information. The process illustrated in FIG. 7 is performed for each viewing apparatus 10. It is assumed that the change information and the view information in the explanation provided below with reference to FIG. 7 correspond to those illustrated in FIG. 4 and FIG. 5, and the individual apparatus basis information illustrated in FIG. 6 is to be created. Moreover, a number of pages of the document ID=1 is set to N (natural number) and n is a number from 1 to N (n=1 . . . N). Although the process of FIG. 7 is performed for each viewing apparatus 10, only the creation of the individual apparatus basis change information with respect the viewing apparatus 10-1 will be explained below. Further, in the process of FIG. 7, it is assumed that all indications of presence or absence of viewed portion change are “X” in the previously created individual apparatus basis change information.

The creation part 124 acquires a page number of a page having a change for each document (for each document ID) by referring to the change information (step S6). Because the pages of the page numbers “1” and “3” are changed (provided with “∘”) in the example of FIG. 4, the creation part 114 acquires the page numbers “1” and “3”. The thus-acquired page numbers are used in step S10 mentioned later.

Next, n is set to 1 (n=1) as an initial setting (step S8). Then, the creation part 124 judges whether the n-th page (here, n=1) was viewed (step S10). In the example of FIG. 5, because the page of the page number n=1 has been viewed by the viewing apparatus 10-1, the result of the judgment is YES and the process proceeds to step S11. In step S11, the creation part 124 creates individual apparatus basis change information. Specifically, as illustrated in FIG. 6, “∘” is given to the page number “1” of the viewing apparatus 10-1 as the indication of presence or absence of viewed portion change.

Then, the process proceeds to step S12. In step s12, the creation part 124 judges whether N is equal to n (N=n), that is, whether the process of S10 and S12 has been performed for all pages having a change. Here, because n is equal to 1 (n=1), that is, n is not equal to N (n≠N), the result of the judgment of step S12 is NO, and the process proceeds to step S14. In step S14, n is incremented by 1.

Then, the process returns to step S10 and the process of step S10 is performed again. Here, because n is equal to 2 (n=2), the creation part 124 judges whether the page having the page number n=2 has been viewed. In the example of FIG. 5, the page of the page number n=2 has not been viewed by the viewing apparatus 10-1, and, thus, the result of the judgment is NO. Accordingly, the indication of presence or absence of viewed portion change is “X”, and the process proceeds to step S12 without updating the individual apparatus basis change information.

The process of steps S10, S11, S12 and S14 is repeated, and the individual apparatus basis change information α is created with respect to the viewing apparatus 10-1.

Then, similarly, the individual apparatus basis change information β and the individual apparatus basis change information γ are created with respect to other viewing apparatuses 10-2 and 10-3, respectively. Then, the transmission/reception part 108 transmits the individual apparatus basis change information to each viewing apparatus 10.

According to the method of creating the individual apparatus basis change information illustrated in FIG. 7, the creation part 124 judges whether the viewed portion indicated in the view information and the changed position indicated in the change information are coincident with each other. Here, in the example of FIG. 5, the viewed portion indicated in the view information with respect to the viewing apparatus 10-1 is the page number 1, 2, . . . of the document ID=001. In the example of FIG. 4, the changed portion indicated in the change information corresponds to the page numbers 1, 3, . . . in the column of page number.

Here, it is interpreted from FIG. 4 that the viewed portion and the changed portion are coincident with each other with respect to the page number 1 (hereinafter, this position is referred to as “coincident position”). Then, if there is a coincident position, the individual apparatus basis change information in which a change history with respect to the incident position is indicated is created. In this example, because the coincident position is the page number=1, the change information of which coincident position is the page number=1 (the presence or absence of viewed portion change in the example of FIG. 6) is set to “∘”. As such, the individual apparatus basis change information for each viewing apparatus 10 is created and transmitted. The individual apparatus basis change information is transmitted to an address of the apparatus to which the view information used for acquiring the coincident position indicated in the individual apparatus basis change information is transmitted.

Moreover, although the coincident position (for example, the first page of the document ID=001) and the positions (for example, the second and third pages of the document ID-001) which do not correspond to the coincident position are indicated in the example of FIG. 6, only the coincident position may be indicated.

According to the information processing apparatus of the present embodiment, the individual apparatus basis change information is created for each viewing apparatus 10, and is transmitted to each viewing apparatus 10, the individual apparatus basis change information indicating a change history with respect to the coincident position where the position viewed by the viewing apparatus 10 (the viewed portion indicated in the view information, that is, a portion important for a user) and the changed portion indicated in the change information. Accordingly, each user can recognize whether the change was made with respect to only positions which the user has viewed (a position that is important for the user). Thus, an effect that there is no need to distinguish the information, which is necessary for the user, can be achieved.

It should be noted that the parts illustrated in FIG. 2 can be realized by a CPU executing a program for causing a computer to perform the process illustrated in FIG. 3. The program may be provided by a non-transitory computer readable recording medium such as a CD-ROM. The program stored in the recording medium is read by a medium drive unit 126 and is supplied to the CPU which achieves the parts illustrated in FIG. 2.

### Second Embodiment

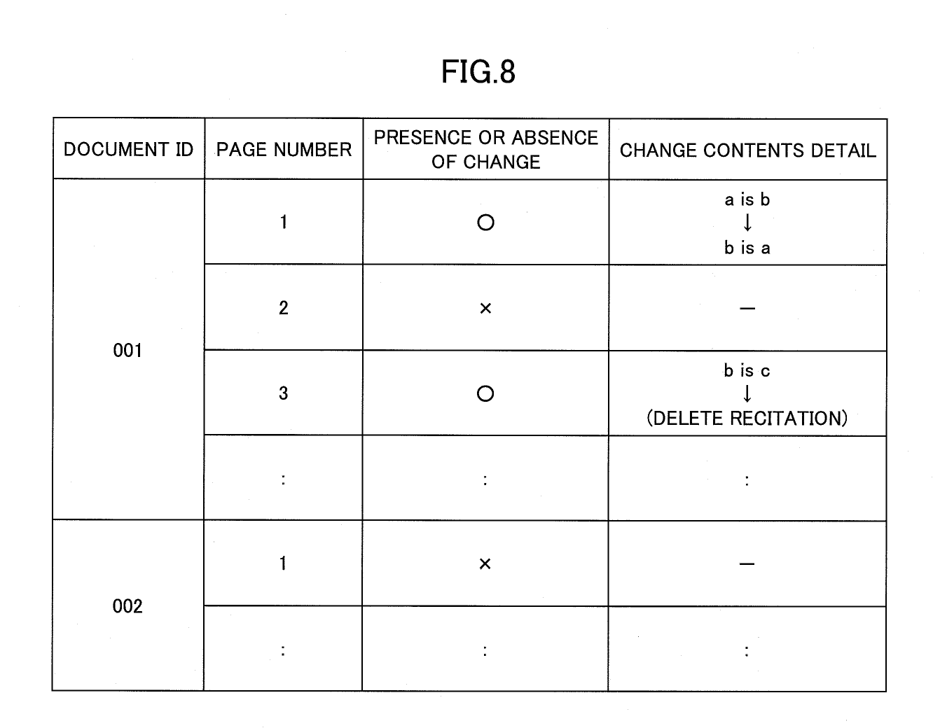

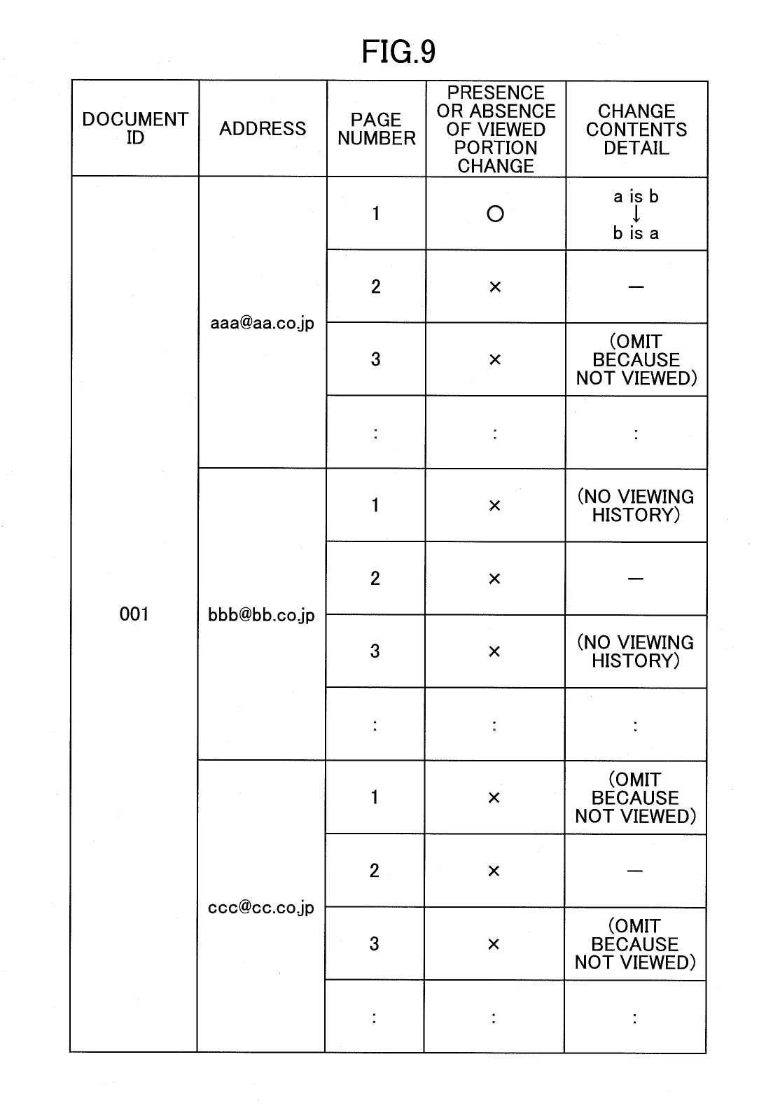

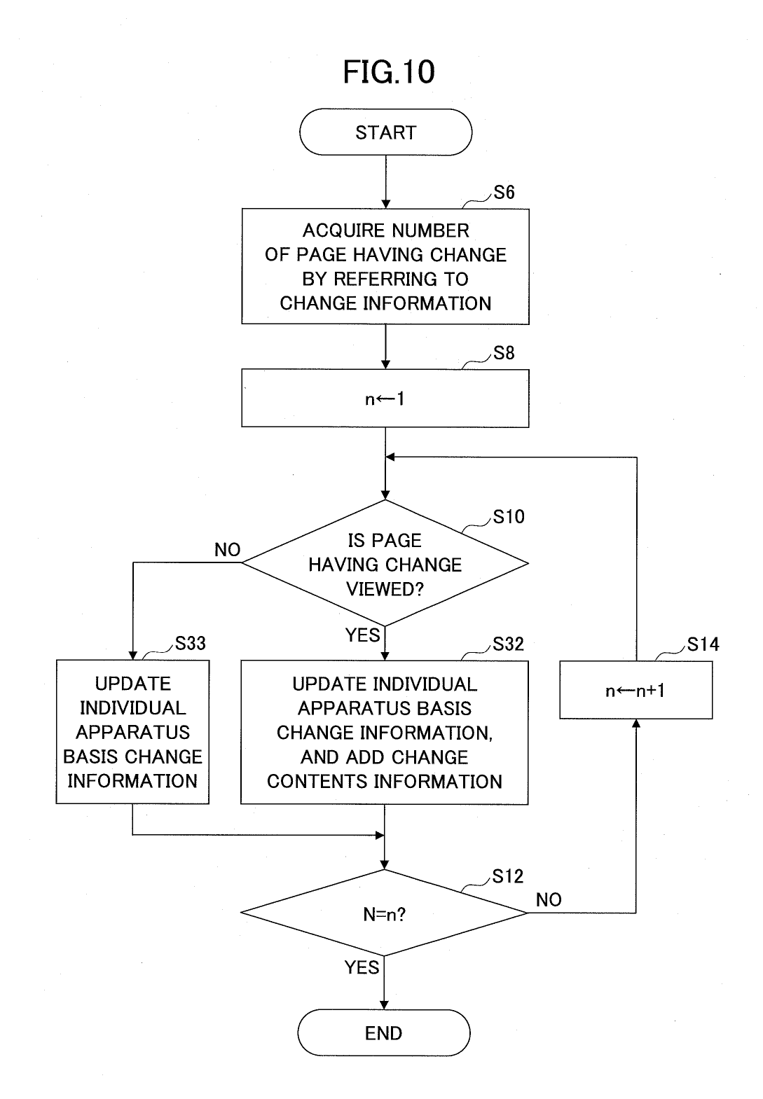

A description will now be given of an information processing apparatus according to a second embodiment. The individual apparatus basis change information used in the second embodiment contains the change contents information. As mentioned above, the change contents information is information regarding changes in contents of a document such as, for example, changing recitation from “a is b” into “b is a” and deleting recitation “b is c”. The change contents information is input to the information processing apparatus 100 by the manager X. FIG. 8 illustrates an example of the change information according to the second embodiment. FIG. 9 illustrates an example of apparatus individual basis change information according to the second embodiment. FIG. 10 illustrates a flowchart of a main process performed by the information processing apparatus according to the second embodiment.

In the example of FIG. 8, the change information contains change contents detail information which indicates that the recitation “a is b” is changed into the recitation “b is a” with respect to the page number 1 of the document ID=1. Additionally, the change information contains change contents detail information which indicates that the recitation “b is c” is deleted with respect to the page number 3 of the document ID=1.

Then, as illustrated in FIG. 10, if the result of the judgment of step S10 is YES, the individual apparatus basis change information is updated (explained with reference to step S11 of FIG. 7) and the change contents information is added (step S32). As a result, the change contents detail information indicating that the recitation “a is b” is changed into the recitation “b is b” is provided to the page number 1 of the document ID=1 of the viewing apparatus 10-1 (aaa@.co.jp) in FIG. 9. Because the change contents detail information is provided in the change information, there is an effect that the user can easily recognize the contents of the change.

On the other hand, if the result of the judgment of step S10 is NO, information indicating that the page concerned was changed is provided to the individual apparatus basis change information (step S33). In the example of FIG. 9, the information indicating that “omit because not viewed” is provided to the individual apparatus basis change information. The user can recognize that the page which the user has not viewed has been changed by viewing the information. It should be noted that the process of step S33 may be omitted.

Moreover, in the example of FIG. 9, the information indicating that there is no viewing history is provided with respect to the viewing apparatus 10-2 because the view information gathering condition indicates as “absence” with respect to the viewing apparatus 10-2, as illustrated in FIG. 5.

According to the information processing apparatus of the second embodiment, the change contents detail information, which indicates the contents of change in the position that has been viewed by the viewing apparatus 10 and has been changed, is contained in the individual apparatus basis change information. Accordingly, there is an advantageous effect that the user can easily recognize the contents of change made in the position where the user has viewed (the position important for the user).

### Third Embodiment

A description will be given of an information processing apparatus according to a third embodiment. In the first and second embodiments, the individual apparatus basis change information is transmitted to each viewing apparatus so that a user visually recognizes the transmitted individual apparatus basis change information, and views the document in which a change has been made. In such a case, the view information must be updated. In the third embodiment, the update part 114 of the information processing apparatus updates the view information when a document is changed by the manager X.

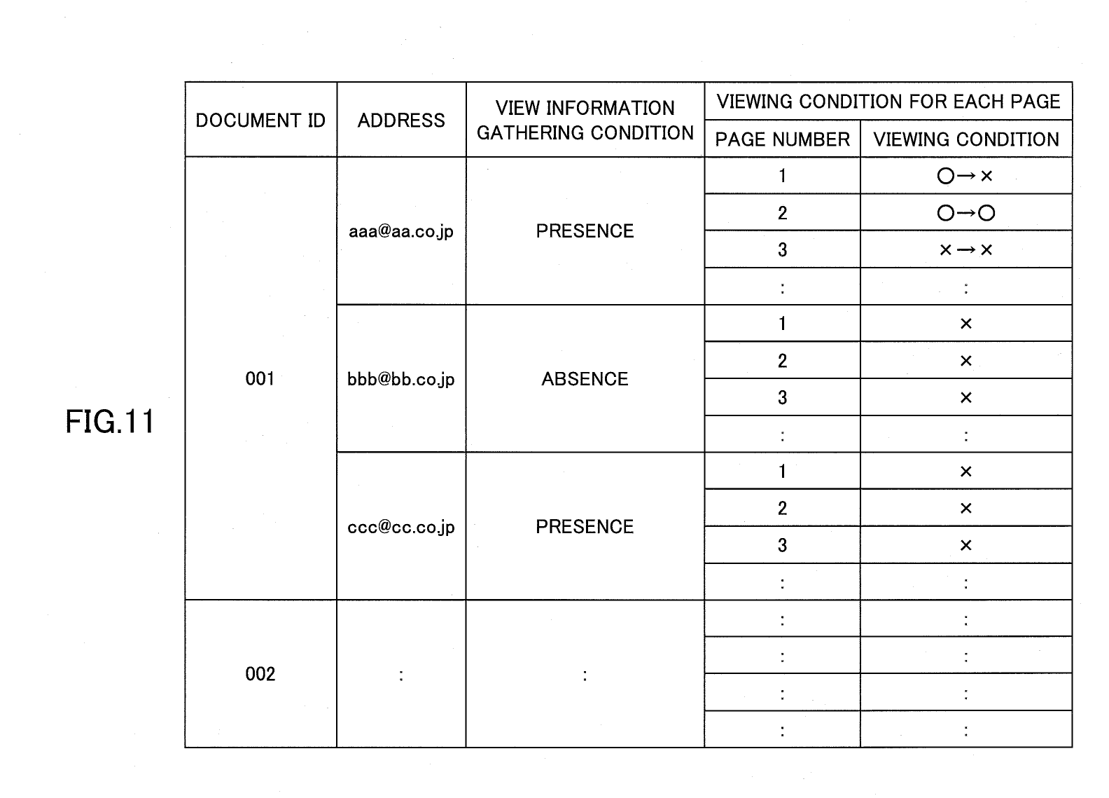

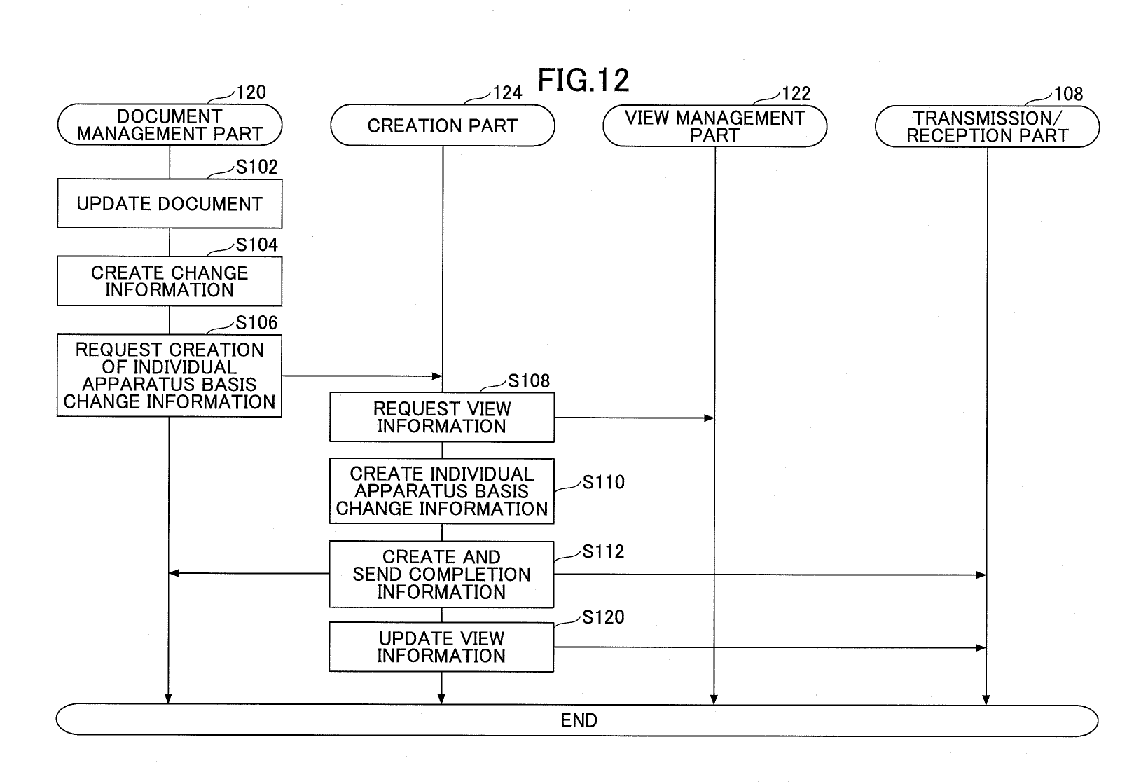

FIG. 11 illustrates an example of the view information according to the third embodiment. FIG. 12 illustrates a flowchart of a main process performed by the information processing apparatus according to the third embodiment. In the present embodiment, the change information illustrated in FIG. 8 is used. In FIG. 8, the recitation “a is b” has been changed into the recitation “b is a” in the first page of the document ID=1. It is assumed that the user A had viewed the first page before the change was made but has not viewed the first page after the change. In such a case, the update part 114 updates the individual apparatus basis change information by changing “∘ (viewed)” into “X (not viewed)” in the first page of the document ID=1 as illustrated in FIG. 11.

Additionally, it is assumed that the user A has viewed the second page of the document ID=1. On the other hand, as illustrated in FIG. 8, the second page of the document ID=2 has not been changed. In such a case, the update part 114 the individual apparatus basis change information by changing “∘ (viewed)” into “∘ (viewed)” in the second page of the document ID=1 as illustrated in FIG. 11.

Further, it is assumed that the user A has not viewed the third page of the document ID=1 before and after the change. In such a case, the update part 114 the individual apparatus basis change information by changing “X (not viewed)” into “X (not viewed)” in the third page of the document ID=1 as illustrated in FIG. 11.

Then, the creation part 124 creates the individual apparatus basis change information with respect to the coincident position between the viewed portion indicated in the view information after the change and the changed portion indicated in the change information.

According to the information processing apparatus of the third embodiment, the view information is also updated each time a change is made in a document. Thus, accurate individual apparatus basis change information can always be created.

### Fourth Embodiment

A description will be given of an information processing apparatus according to a fourth embodiment. In the first embodiment, the individual apparatus basis change information is transmitted to the corresponding viewing apparatus in step S112 illustrated in FIG. 3. On the other hand, in the fourth embodiment, an address of the document in which a change was made (hereinafter, may be referred to as a document after change) is transmitted together with the individual apparatus basis change information.

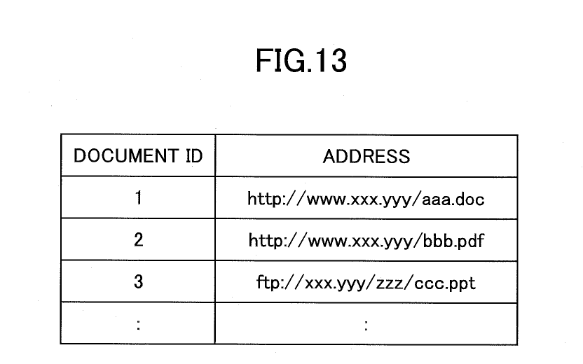

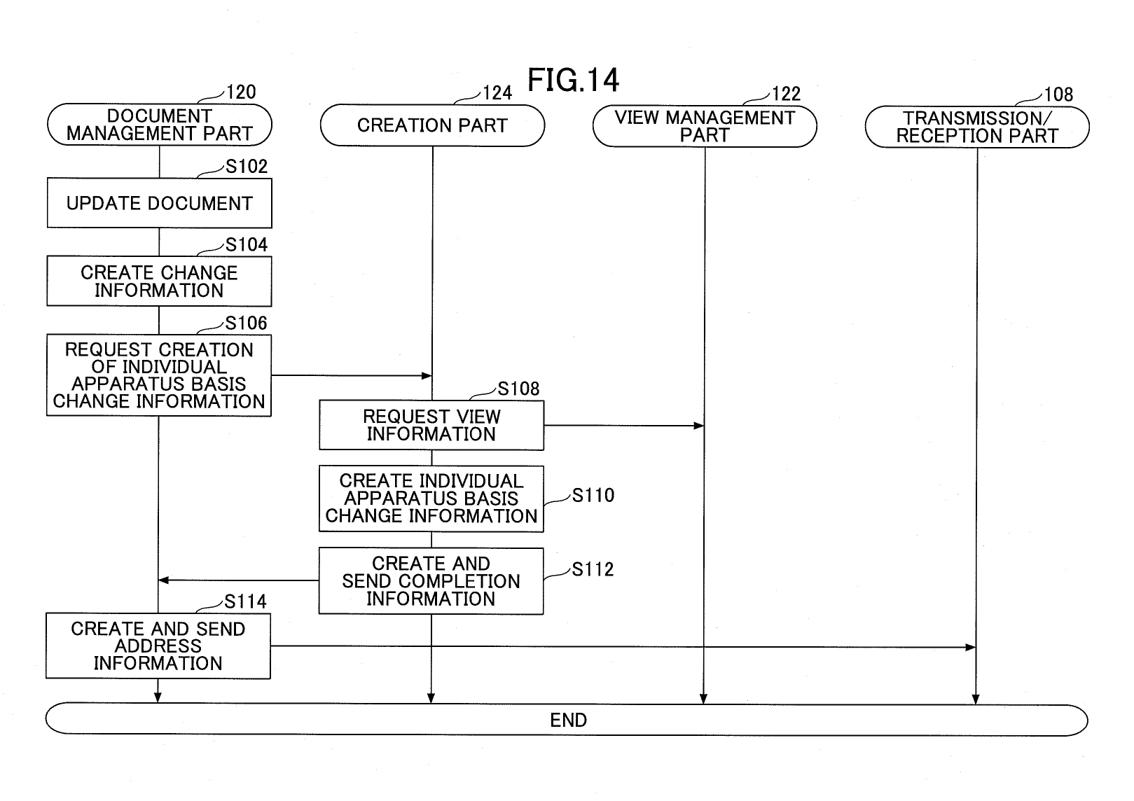

FIG. 13 illustrates a correspondence table indicating correspondence between documents and addresses in which the documents are stored. FIG. 14 illustrates a flowchart of a main process performed by the information processing apparatus according to the fourth embodiment. The document management part 120 retains the correspondence table illustrated in FIG. 13 (stored in the second storage 112). When the creation part 124 creates the individual apparatus basis change information (step S110 of FIG. 14) and sends the completion information to the document management part 120 (step S112), the document management part 120 retrieves the address of the document in which a change was made from the correspondence table illustrated in FIG. 13, and creates address information in which the retrieved address is indicated, and sends the address information to the transmission/reception part 108 (step S114). Then, the transmission/reception part 108 transmits the address information of the document in which a change was made together with the individual apparatus basis change information.

For example, when the document of the document ID=1 has been changed, the document management part 120 sends in step S114 the address information in which the address “http://www.xxx.yyy/aaa.doc” corresponding to the document ID is indicated. Then, the transmission/reception part 108 transmits the address information to each viewing apparatus together with the individual apparatus basis change information.

The viewing apparatus which received the address information can acquire, through the network 50, the document stored in the address indicated in the received address information. For example, a display part (not illustrated in the figure) of the viewing apparatus, which received the individual apparatus basis change information and the address information, is caused to display a selection screen to select whether to acquire the document after change. The user who recognized the selection screen becomes capable of selecting whether to acquire the document after change.

If the user desires to view the document after change, the user selects “acquire the document after change.” Then, the viewing apparatus requests the document after change by transmitting a document request signal to the information processing apparatus 100. Upon reception of the document request signal, the information processing apparatus 100 returns the document after change requested by the document request signal. According to such a process flow, the information processing apparatus 100 can acquire the document after change to have the user view the document after change.

According to the information processing apparatus of the fourth embodiment, the transmission/reception part 108 transmits the address of the document in which a change has been made together with the individual apparatus basis change information. Accordingly, the user can view the document after change by acquiring the document stored at the address by the viewing apparatus 10. Additionally, the user can select whether to view the document after change.

Moreover, as a variation of the fourth embodiment, not the address of the document after change but the document after change itself may be transmitted together with the individual apparatus basis change information. In this variation, the user is allowed to immediately view the document after change.

### Fifth Embodiment

A description will be given of an information processing apparatus according to a fifth embodiment. According to the fifth embodiment, the change contents information (refer to FIG. 8) indicating the contents of change in a document is integrated or incorporated into the document. Then, the document into which the change contents information is integrated and the individual apparatus basis change information are transmitted to each viewing apparatus.

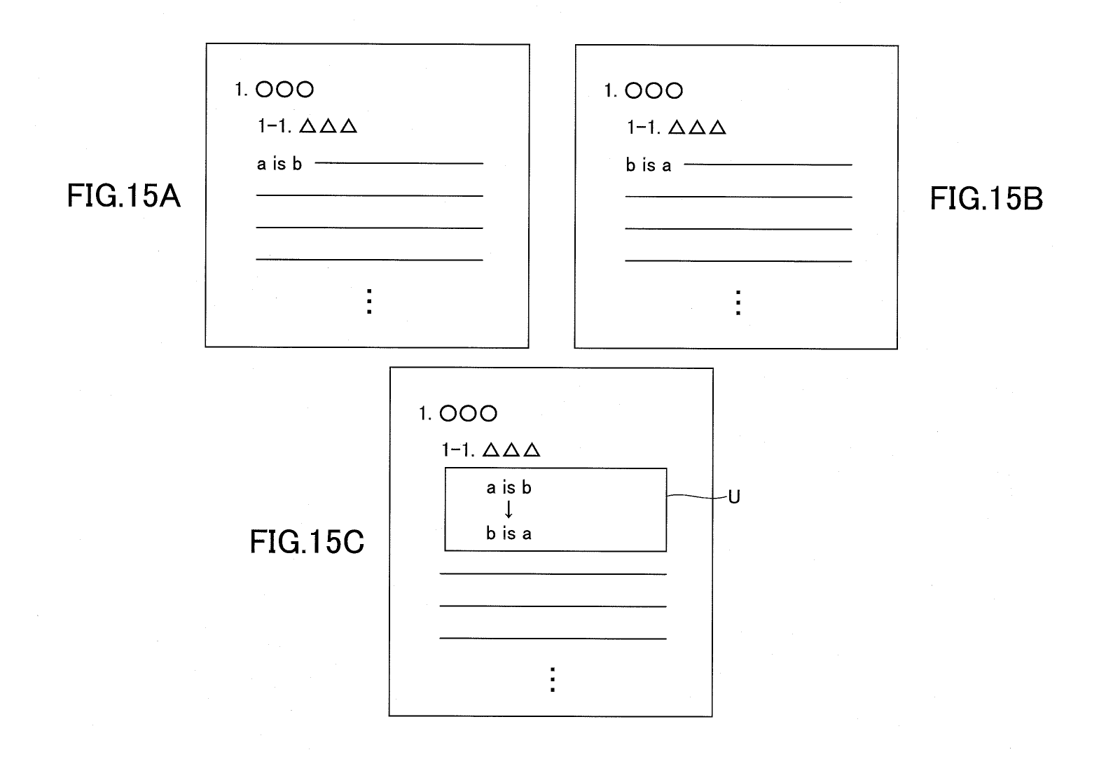

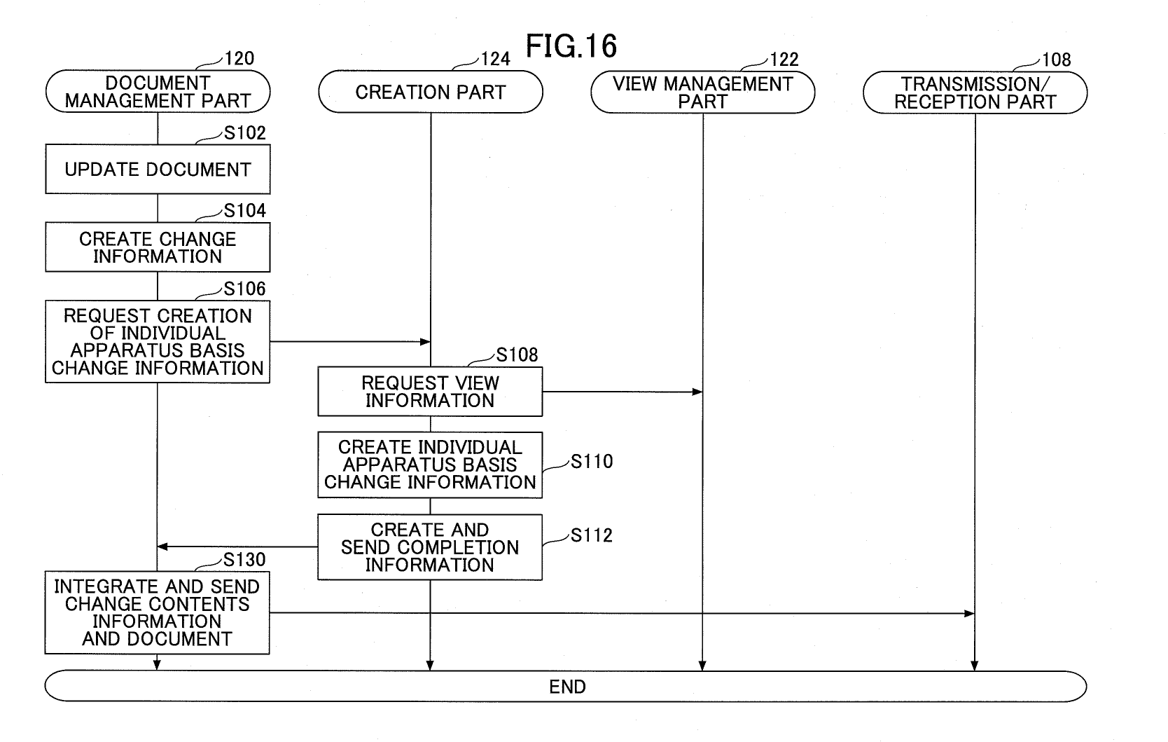

FIGS. 15A through 15C illustrates examples of the document used in the fifth embodiment. Specifically, FIG. 15A illustrates an example of a document before change, FIG. 15B illustrates an example of the document after change, and FIG. 15C illustrates an example of the document after integration. FIG. 16 is a flowchart of a main process performed by the information processing apparatus according to the fifth embodiment.

As illustrated in FIG. 15A, the recitation before change is “a is b”, and the recitation after change is “b is a”. That is, the change contents information (explained in the first embodiment) is {“a is b”→“b is a”}. The creation part 124 creates the individual apparatus basis change information (step S110), and sends the completion information and the created individual apparatus basis change information to the document management part 120 (step S112). The integration part 116 acquires the change contents information from the document management part 120. Then, the integration part 116 integrates the acquired change contents information into the document in which a change has been made (in the example, the document corresponding to the document ID=001).

The document after integration is illustrated in FIG. 15C. As illustrated by a portion indicated by U in FIG. 15C, the change contents information {“a is b”→“b is a”} is integrated into the document of the document ID=001. Then, the document management part 120 sends the document in which the change contents information is incorporated and the individual apparatus basis change information to the transmission/reception part 108 (step S130). Then, the transmission/reception part 108 transmits the document in which the change contents information is incorporated and the individual apparatus basis change information to the corresponding viewing apparatus 10.

According to the fifth embodiment, the document in which the change contents information is incorporated is transmitted to the viewing apparatus together with the individual apparatus basis change information. Accordingly, the user can immediately view the contents of change by viewing the document in which the change contents information is integrated, and can easily recognize the contents of change.

Moreover, as a variation of the fifth embodiment, the document in which the change contents information is integrated and the individual apparatus basis change information are not transmitted but the changed portion (that is, the change contents information) and the individual apparatus basis change information may be transmitted to the corresponding viewing apparatus. In a case of such a structure, the extraction part 118 extracts the changed portion of the document in which a change was made. Then, the transmission/reception part 108 transmits the changed portion and the individual apparatus basis change information. In the case of this variation, there is no need to transmit the entire document to each viewing apparatus 10, and, thus, a transmission cost can be reduced.

### Another Embodiment

In the above-mentioned first through fifth embodiments, the parts illustrated in FIG. 2 are incorporated into a single housing as the information processing apparatus 100. As another embodiment, at least one of the parts illustrated in FIG. 2 may be incorporated into a different housing to constitute a document processing system. In this case, communication between the parts incorporated in the two housings may be performed through the network 50. By constituting a document processing system as mentioned above, load sharing can be achieved.

The present invention is not limited to the specifically disclosed embodiments, and variations and modifications may be made without departing from the scope of the present invention.

The present application is based on Japanese priority application No. 2011-038083 filed on Feb. 24, 2011, the entire contents of which are hereby incorporated herein by reference.

What is claimed is:

1. An information processing apparatus to be connected to a viewing apparatus through which a document is viewed, the information processing apparatus comprising:
a view management part configured to create view information that indicates a viewed portion of said document where said document has been viewed;
a document management part configured to create change information that indicates a changed portion of said document where said document has been changed;
a creation part configured to create individual apparatus basis change information that indicates a coincident portion where the viewed portion indicated in said view information and the changed portion indicated in said change information are coincident with each other; and
a transmission part configured to transmit said individual apparatus basis change information to said viewing apparatus through which said document was viewed.

2. The information processing apparatus as claimed in claim 1, wherein said creation part creates said individual apparatus basis change information containing change contents information indicating contents of change of said changed portion.

3. The information processing apparatus as claimed in claim 1, further comprising an update part configured to update said view information, wherein said creation part creates the individual apparatus basis change information that indicates the incident portion where the viewed portion indicated in said view information that is updated by said update part and the changed portion indicated in said change information are coincident with each other.

4. The information processing apparatus as claimed in claim 1, wherein said transmission part transmits, together with said individual apparatus basis change information, said document that has been changed or an address of said document that has been changed.

5. The information processing apparatus as claimed in claim 1, further comprising
an integration part configured to integrate change contents information indicating contents of a change into said document before the change, wherein said transmission part transmits, together with said individual apparatus basis change information, said document in which said change contents information has been integrated by said integration part.

6. The information processing apparatus as claimed in claim 1, further comprising an extraction part configured to extract said changed portion from said document, wherein said transmission part transmits, together with said individual apparatus basis change information, said changed portion extracted by said extraction part.

7. An information processing method comprising:
a step of creating view information that indicates a viewed portion of a document where said document has been viewed through a viewing apparatus;
a step of creating change information that indicates a changed portion of said document where said document has been changed;
a step of creating individual apparatus basis change information that indicates a coincident portion where the viewed portion indicated in said view information and the changed portion indicated in said change information are coincident with each other; and
a step of transmitting said individual apparatus basis change information to said viewing apparatus through which said document was viewed.

8. The information processing method as claimed in claim 7, wherein said individual apparatus basis change information contains change contents information indicating contents of change of said changed portion.

9. The information processing method as claimed in claim 7, further comprising a step of updating said view information, wherein the individual apparatus basis change information indicates the incident portion where the viewed portion indicated in said view information that is updated in said step of updating and the changed portion indicated in said change information are coincident with each other.

10. The information processing method as claimed in claim 7, wherein said step of transmitting transmits, together with said individual apparatus basis change information, said document that has been changed or an address of said document that has been changed.

11. The information processing method as claimed in claim 7, further comprising a step of integrating change contents information indicating contents of a change into said document before the change, wherein said step of transmitting transmits, together with said individual apparatus basis change information, said document in which said change contents information has been integrated by said step of integrating.

12. The information processing method as claimed in claim 7, further comprising a step of extracting said changed portion from said document, wherein said step of transmitting transmits, together with said individual apparatus basis change information, said changed portion extracted by said step of extracting.

13. A non-transitory computer readable recording medium storing a program to cause a computer to perform an information processing method, the information processing method comprising:
a step of creating view information that indicates a viewed portion of a document where said document has been viewed through a viewing apparatus;
a step of creating change information that indicates a changed portion of said document where said document has been changed;
a step of creating individual apparatus basis change information that indicates a coincident portion where the viewed portion indicated in said view information and the changed portion indicated in said change information are coincident with each other; and
a step of transmitting said individual apparatus basis change information to said viewing apparatus through which said document was viewed.

14. The non-transitory computer readable recording medium as claimed in claim 13, wherein said individual apparatus basis change information contains change contents information indicating contents of change of said changed portion.

15. The non-transitory computer readable recording medium as claimed in claim 13, wherein the information processing method further comprises a step of updating said view information, wherein the individual apparatus basis change information indicates the incident portion where the viewed portion indicated in said view information that is updated in said step of updating and the changed portion indicated in said change information are coincident with each other.

16. The non-transitory computer readable recording medium as claimed in claim 13, wherein said step of transmitting transmits, together with said individual apparatus basis change information, said document that has been changed or an address of said document that has been changed.

17. The non-transitory computer readable recording medium as claimed in claim 13, wherein the information processing method further comprises a step of integrating change contents information indicating contents of a change into said document before the change, wherein said step of transmitting transmits, together with said individual apparatus basis change information, said document in which said change contents information has been integrated by said step of integrating.

18. The non-transitory computer readable recording medium as claimed in claim 13, wherein the information processing method further comprises a step of extracting said changed portion from said document, wherein said step of transmitting transmits, together with said individual apparatus basis change information, said changed portion extracted by said step of extracting.
